(19) United States
(12) Patent Application Publication
(10) Pub. No.: US 2007/0023026 A1
(43) Pub. Date: Feb. 1, 2007

(54) Dicing blade

(76) Inventor: Broyles Michelle, Golden, CO (US)

Correspondence Address: The Halvorson Law Firm, Ste 130, 1757 E. Baseline Rd., Gilbert, AZ, 85233, US

(21) Appl. No.: 11/194,027

(22) Filed: Jul. 28, 2005

(51) Int. Cl. B28D 1/04

(52) U.S. Cl. 125/15

(57) ABSTRACT

A blade for the dicing of silicon wafers comprising a diamond particle containing matrix, said blade having a trapezoidal cross section.

### FIELD OF THE INVENTION

The present invention relates generally to the dicing of solid state materials. More specifically, the present invention relates to a new blade for the dicing of wafers.

### BACKGROUND OF THE INVENTION AND DESCRIPTION OF THE PRIOR ART

Die separation, or dicing, by sawing is the process of cutting a microelectronic substrate into its individual circuit die with a rotating circular abrasive saw blade. This process has proven to be the most efficient and economical method in use today. It provides versatility in selection of depth and width (kerf) of cut, as well as selection of surface finish, and can be used to saw either partially or completely through a wafer or substrate.

Wafer dicing technology has progressed rapidly, and dicing is now a mandatory procedure in most front-end semiconductor packaging operations. It is used extensively for separation of die on silicon integrated circuit wafers. Increasing use of microelectronic technology in microwave and hybrid circuits, memories, computers, defense and medical electronics has created an array of new and difficult problems for the industry. More expensive and exotic materials, such as sapphire, garnet, alumina, ceramic, glass, quartz, ferrite, and other hard, brittle substrates, are being used. They are often combined to produce multiple layers of dissimilar materials, thus adding further to the dicing problems. The high cost of these substrates, together with the value of the circuits fabricated on them, makes it difficult to accept anything less than high yield at the die-separation phase.

Dicing semiconductor wafers by sawing is an abrasive machining process similar to grinding and cutoff operations that have been in use for decades. However, the size of the dicing blades used for die separation makes the process unique. Typically, the blade thickness ranges from 0.6 mils to 500 mils, and diamond particles (the hardest well known material) are used as the abrasive material ingredient. Because of the diamond dicing blade's extreme fineness, compliance with a strict set of parameters is imperative, and even the slightest deviation from the norm could result in complete failure.

The diamond blade is a cutting tool in which each exposed diamond particle comprises a small cutting edge. Various dicing blades are available commercially. By way of example, a sintered diamond blade includes diamond particles which are fused into a soft metal such as brass or copper, or incorporated by means of a powdered metallurgical process; a plated diamond blade includes diamond particles which are held in a nickel bond produced by an electroplating process; and a resinoid diamond blade is one in which diamond particles are typically held in a resin bond to create a homogeneous matrix. Silicon wafer dicing typically uses the plated diamond blade, which has proven to be most successful for this application.

Because most state-of-the-art dicing equipment has been designed specifically to dice silicon wafers, problems arise when it is necessary to cut harder and/or more brittle materials. Blade speed and torque, depth of cut, feed rate, and other performance parameters have been optimized for silicon. However, hard and brittle materials require different blades and equipment operating parameters, the proper selection of which is a key to success for high-yield dicing. In any cutting operation, tool sharpness is of primary importance. More exactly, it is necessary that the cutting tool maintain its sharpness throughout the cutting operation. When cutting hard material such as sapphire or garnet, the cutting edges become dull quite rapidly. Because the dulled cutting edges cannot be re-sharpened in the usual manner, it is desirable that they be pulled loose from the blade, or else be fractured to expose new sharp cutting edges.

An important characteristic of the resinoid diamond blade that promotes effective cutting is its self-sharpening ability. The blade requires no dressing at all, in contrast to most metal-bonded (sintered or electroplated) diamond blades. Sharpening is accomplished automatically by the cutting process. As a cutting edge becomes dull, it experiences increased cutting forces that eventually either pull the diamond particle loose from the blade or else fracture it to produce a new sharp cutting edge. A diamond blade that does not exhibit this property cannot properly cut hard materials, nor can it perform properly if saw operating parameters interfere with the self-sharpening mechanism.

There remains a need to for better and more economical dicing blades.

### SUMMARY OF THE INVENTION

It is an object of the present invention to provide a novel dicing blade comprising a diamond in a matrix

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. § 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the preferred embodiment.

FIG. 2 is a cut-away view of the present invention along line 2-2.

FIG. 3. is a side view of an alternate embodiment.

FIG. 4 is a perspective view of an alternate embodiment.

FIG. 5. is a side view of yet another alternate embodiment.

FIG. 6 is a perspective view of yet another alternate embodiment.

### DETAILED DESCRIPTION OF PREFERERED EMBODIMENTS

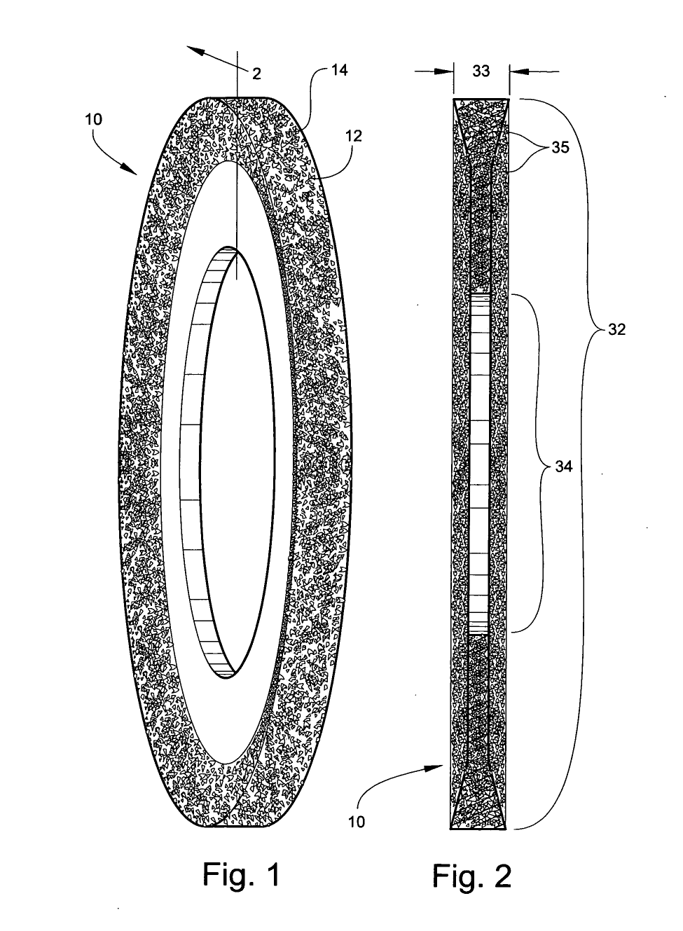

FIG. 1 shows a dicing blade according to the present invention. The dicing blade 10 is shown as having an outside diameter 32, an inside diameter 34, an outer diameter thickness 33, and an inner diameter thickness 35. Each of these dimensions can be generally varied over wide ranges, depending on the particular application of the particular dicing blade. For example, suitable dicing blades can be produced having a outside diameter ranging from 2.2 inches or smaller, to 4.7 inches or greater. Other blade sizes can readily be produced, without or without this range, by making minor tooling adjustments, as would be readily apparent to those of ordinary skill in the art. Suitable diameter dimensions are disclosed, for example, in U.S. Pat. Nos. 5,637,388 and 5,494,698, the entire disclosures of which are incorporated herein by reference.

According to the present invention, the dicing blade 10 is generally a diamond 12 in a matrix 14. The blade 10 has a relatively hard, dense matrix 14 bonded base material, such as resins or soft metals, preferably with substantially no abrasive fillers, and contains a suitable concentration of natural or synthetic diamonds 12. Such dicing blades 10 are generally known in the art, as disclosed in, for example, U.S. Pat. No. 4,878,992, the entire disclosure of which is incorporated herein by reference.

Although compositions for dicing blades 10 are generally known in the art, an exemplary dicing blade 10 according to the present invention has the outer diameter thickness 33 greater than the inner diameter thickness 35. For example, a particular dicing blade 10 can have an outer diameter thickness 33 of 20 thousands and an inner diameter thickness 35 of 5 thousands. Generally the ratio of outer diameter to inner diameter thickness ranges from 3/1 to 10/1. Of course, these ratios are not limiting and can be varied depending on particular blade designs.

According to the present invention, the dicing blade 10 preferably contains little or no abrasive fillers, and instead has a high density fine diamond 12 distribution in which the diamond acts as the abrasive medium. In embodiments of the present invention, the diamonds 12 may be natural or synthetic, and preferably have a nominal diamond size range of from 1 to 20 micrometers, preferably 1 to 10 micrometers, and more preferably 2 to 6 micrometers. The diamond 12 concentration in the blade 10 is preferably from about 80 to about 140%, more preferably 90 to 130%, and even more preferably 100 to 120%, and still more preferably 105 to 115%, where 100% corresponds to 72 carats/cubic inch. However, as will be apparent to those skilled in the art, the diamond size and concentration can be readily varied based on particular applications of the resultant dicing blade.

The dicing blades 10 of the present invention can be made according to any of the various methods known in the art, with the modification of differing outer and inner diameters. For example, as described above, the blade 10 can be formed using a backfilling technique, as described in U.S. Pat. No. 5,494,698. Alternatively, the blade 10 can be formed using the process described in U.S. Pat. No. 5,637,388, the entire disclosure of which is incorporated herein by reference.

Methods of using the dicing blade 10 of the present invention will be readily apparent to those skilled in the art. In particular, the dicing blade 10 of the present invention can be used in any of the various dicing methods practiced (or subsequently developed) in the art.

However, the dicing blade 10 of the present invention provides several significant advantages over prior art dicing blades in such dicing operations. In particular, it has been found that using the dicing blade 10 of the present invention provides significantly decreased wear rates of the dicing blade 10. For example, comparative use of the dicing blade 10 of the present invention versus a similar dicing blade not having differing outer and inner diameters, shows that the dicing blade 10 of the present invention has as much as a 25% decrease in wear of the blade. This not only provides increased process throughput, but also provides more economical processing due to a lower need to replace the dicing blade 10. The dicing blade 10 of the present invention also exhibits less asymmetric wear on the periphery of the blade 10, which in turn provides the benefit of reducing the need to redress the blade 10 during the dicing operation. Less asymmetric wear also results in more consistent dimensional quality of the diced chip.

Furthermore, the dicing blade 10 of the present invention provides more precise cutting with less chipping, both of the dicing blade 10 and of the semiconductor substrate being cut.

Still further, it has been found that the dicing blade 10 of the present invention exhibits less bending during the dicing operation. This allows the dicing operation to provide more precise cuts, an advantage that is becoming more and more important as the size of microelectronics continues to decrease.

The dicing blade 10 of the present invention can be used for a variety of precision cutting purposes in other areas. For example, the dicing blades can be used in any of the various operations in the microelectronics area, such as during the fabrication of electrical semiconductor chips or for constructing raster input scan (RIS) sensor bars. The dicing blades 10 can similarly be used in the construction of magnetic heads. For example, the present invention is particularly advantageous in the dicing of microelectronic chips made from gallium arsenide, which tend to chip and break easily in the cutting operations.

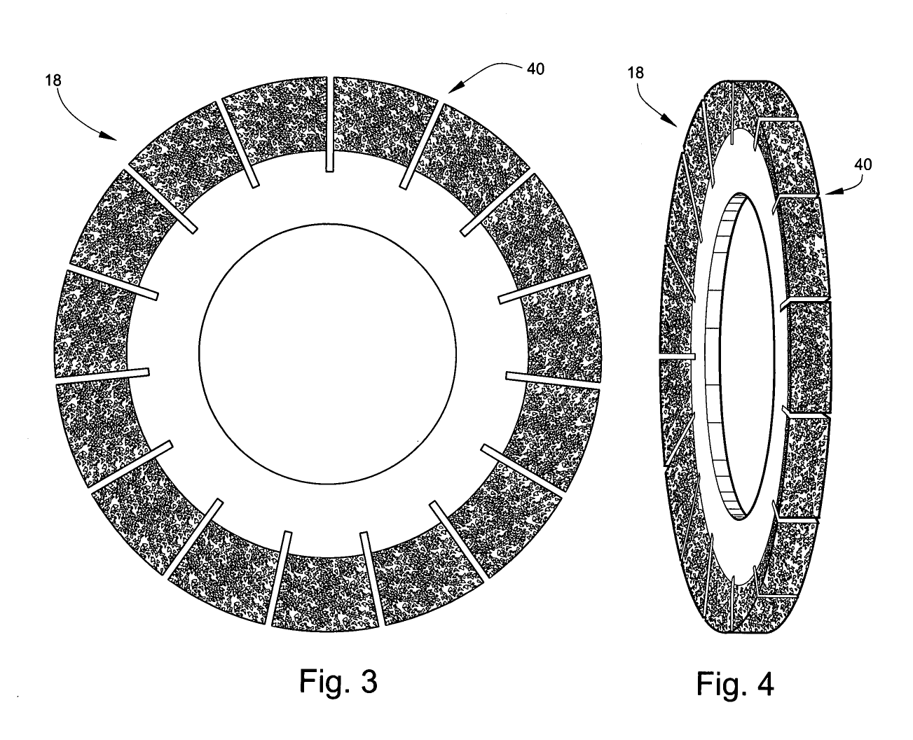

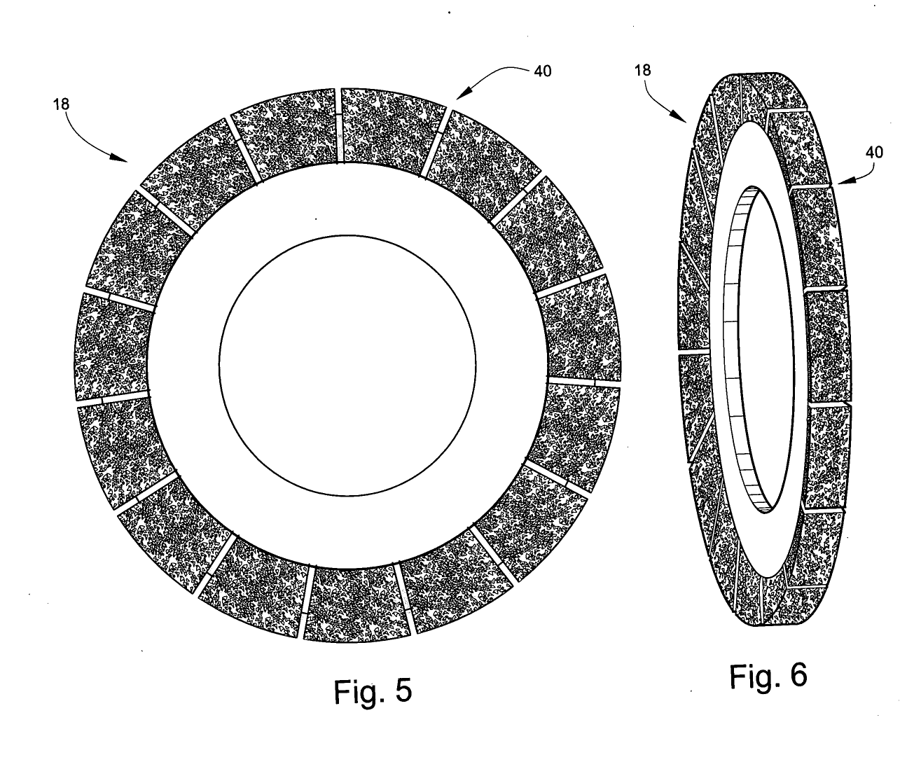

An alternate embodiment of the present invention is shown in FIGS. 3 and 4, where the blade 18 further includes a series of radial slots 40 in the periphery of the blade 10. Further, as shown in FIGS. 5 and 6, the blade 18 with radial slots 40 may be laid down onto a central disk such that the central disk extends through at least a portion of the radial slot 40 in the diamond/matrix composition.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A blade for cutting solid state materials comprising a diamond comprising matrix having an outer diameter greater than an inner diameter and an outer diameter thickness greater than an inner diameter thickness wherein the ratio of outer diameter thickness to inner diameter thickness ranges from 3/1 to 10/1.

2. The blade according to claim 1 wherein the matrix is a resinoid.

3. The blade according to claim 1 wherein the matrix is a soft metal.

4. (canceled)

5. (canceled)
